(19) United States
(12) Patent Application Publication
(10) Pub. No.: US 2010/0134303 A1
(43) Pub. Date: Jun. 3, 2010

(54) FLUID LEVEL DETECTOR FOR AN INFUSION FLUID CONTAINER

(76) Inventor: James T. Perkins, St. Charles, MO (US)

Correspondence Address: Michael L. Smith;Bausch & Lomb Incorporated, One Bausch & Lomb Place, Rochester, NY, 14604-2701, US

(21) Appl. No.: 12/326,159

(22) Filed: Dec. 2, 2008

(51) Int. Cl. G08B 21/00

(52) U.S. Cl. 340/619

(57) ABSTRACT

A fluid level sensing assembly includes a clamp that securely clamps a fluid level detector in place on a rigid walled infusion container, to minimize movement during use of the infusion container and fluid level detector. The fluid level detector includes a light sensor array and a light source. The light sensor array is positioned vertically relative to a side wall and senses light at various points vertically along the light sensor array. The light source is positioned vertically relative to the side wall and projects light linearly through a vertical portion of the side wall. An incidence angle α of the light source relative to the side wall is selected such that a light beam emitted by the light source is reflected when a transmission path of the light beam intersects either a side wall/fluid interface or a side wall/air interface. Accordingly, when infusion fluid is absent in a vertical location of the container, the light sensor array outputs a signal based on a presence or absence of light at a sensor location adjacent the vertical location and corresponds to whether there is a presence or absence of infusion fluid at the vertical location, to indicate the level of infusion fluid within the container.

### FIELD

The present disclosure relates to an ophthalmic surgical system employing an infusion fluid container. More specifically, the present disclosure relates to an infusion fluid container and fluid level sensor.

### BACKGROUND

This section provides background information related to the present disclosure which is not necessarily prior art.

It is common for ophthalmic surgical systems to include a container for holding infusion fluid used for irrigation purposes during surgical procedures. Ophthalmic surgical systems typically draw infusion fluid from a container through an irrigation tube to the surgical site, where the fluid is aspirated to a fluid collection cassette in which a vacuum is applied. During surgery, a surgical console typically has sensors and indicator icons and audible alerts for when aspiration flow is presumed to have ceased, while still applying a vacuum to the aspiration tubing. Such schemes generally are sufficient to allow safe operation of the surgical cassette. However, it would be desirable for an operator to easily determine the level of fluid in the interior volume of the infusion container, to provide easy and convenient feedback to the surgeon that infusion fluid is present and at least an estimate of an amount of fluid present.

### SUMMARY

This section provides a general summary of the disclosure, and is not a comprehensive disclosure of its full scope or all of its features. The present disclosure relates to a fluid level sensing assembly for connection to an infusion fluid container for use in ophthalmic surgical systems. According to one aspect of the present disclosure, a fluid level sensing assembly adapted to be connected to an infusion fluid container is provided that includes a rigid walled container having an interior volume, and at least a container side wall defining a portion of the interior volume. The fluid level sensing assembly includes a clamp that securely clamps a fluid level detector in place on the container, to minimize movement during use of the infusion container and fluid level sensor assembly. The fluid level detector includes a light sensor array and a light source, where the light sensor array is positioned vertically relative to the side wall, and senses light at various points vertically along the light sensor array. The fluid level sensing assembly includes a light source positioned vertically relative to the side wall, which is configured to project light linearly through a vertical portion of the side wall. The incidence angle α of the light source relative to the container wall is selected such that a light beam emitted by the light source is reflected when the transmission path of the light beam intersects either a side wall/fluid interface or a side wall/air interface. Accordingly, when infusion fluid is not present in a vertical location of the container, the light sensor array outputs a signal based on the presence of light at the given sensor location that corresponds to whether there is a presence or absence of infusion fluid at the vertical location, to thereby detect the level of infusion fluid within the container.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a side elevation view of one embodiment of a fluid level sensor assembly in combination with an infusion fluid container, in accordance with the principles of the present disclosure;

FIG. 2 shows a cross-sectional view of the fluid level sensor assembly and container taken along line 2-2 of FIG. 1;

FIG. 3 shows a cross-sectional view of the fluid level sensor assembly and container taken along line 3-3 of FIG. 1;

FIG. 4 shows a cross-sectional view of the fluid level sensor assembly and container taken along line 4-4 of FIG. 2;

FIG. 5 shows a side elevation view of a second embodiment of a fluid level sensor assembly in combination with an infusion fluid containing device, in accordance with the principles of the present disclosure;

FIG. 6 shows a top-plane view of the fluid level sensor assembly and container shown in FIG. 5, in accordance with the principles of the present disclosure; and

FIG. 7 shows a cross-sectional view of the fluid level sensor assembly and container taken along line 7-7 of FIG. 6, in accordance with the principles of the present disclosure.

Corresponding reference numerals indicate corresponding parts throughout the several views of the drawings.

### DETAILED DESCRIPTION

Example embodiments will now be described more fully with reference to the accompanying drawings. The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

In the various embodiments, a fluid level sensing assembly connected to an infusion fluid container is provided. The fluid level sensing assembly is typically attached to a rigid walled container having an interior volume, and at least a container side wall defining a portion of the interior volume. The fluid level sensing assembly includes a clamp for securely clamping a fluid level detector in place on the container, to minimize movement during use of the infusion container and fluid level sensor assembly. The fluid level detector includes a light sensor array and a light source, where the light sensor array is positioned vertically relative to the side wall and senses light at various points vertically along the light sensor array. The fluid level sensing assembly includes a light source positioned vertically relative to the side wall, which is configured to project light linearly through a vertical portion of the side wall. The incidence angle α of the light source relative to the side wall is selected, such that a light beam emitted by the light source is reflected when the transmission path of the light beam intersects either a side wall/fluid interface or a side wall/air interface. Accordingly, when infusion fluid is not present in a vertical location of the container, the light sensor array outputs a signal based on the presence of light at the given sensor location that corresponds to whether there is a presence or absence of infusion fluid at the vertical location, to thereby detect the level of infusion fluid within the container.

According to one aspect of the present disclosure, a fluid level sensing device connected to an infusion fluid container is provided. The fluid level sensor device includes a light sensor, such as a photo-detector, for detecting a fluid level through the physics of light transmission between boundaries of materials having different indexes of refraction. When light intersects a boundary between two mediums at a right angle, almost all of the light is transmitted through the boundary. However, when light intersects a boundary between two mediums at an angle of less than 90 degrees, some of the light is transmitted and some of the light is reflected. Both the angle of the light and the change in the index of refraction between the two mediums determines how much of the light is transmitted and how much of the light is reflected. This principle is applied to detect the fluid level in the container.

Detecting the level of fluid in an infusion container with a light sensor or photo-detector, such as a contact image sensor, involves two sets of boundary conditions. One set of boundary conditions exists below the fluid level and another set of boundary conditions exist above the fluid level. Both sets of boundary conditions have two possible interfaces. A first interface is between the side wall material and air, and a second interface is between the side wall material and the contents of the container, i.e., infusion fluid. The first interface, between air and side wall material, is insignificant since the amount of light reflected will be the same independent of the contents of the container. The second interface, between the side wall material and the container contents is of most importance, since the amount of reflective light is directly related to the contents of the container.

By tailoring the reflection and the transmission characteristics with respect to the side wall and a light sensor array, a difference between the fluid present and the fluid absent can be sensed. The amount of light received by the light sensor array is directly proportional to the amount of light reflected at the medium boundaries. By monitoring the amount of light received by one or more light sensors, the fluid level can be determined based on the point at which the intensity of the reflected light changes. As used herein, the term “light” will generally refer to electromagnetic radiation, preferably electromagnetic radiation in the infrared, visible, and ultraviolet wavebands.

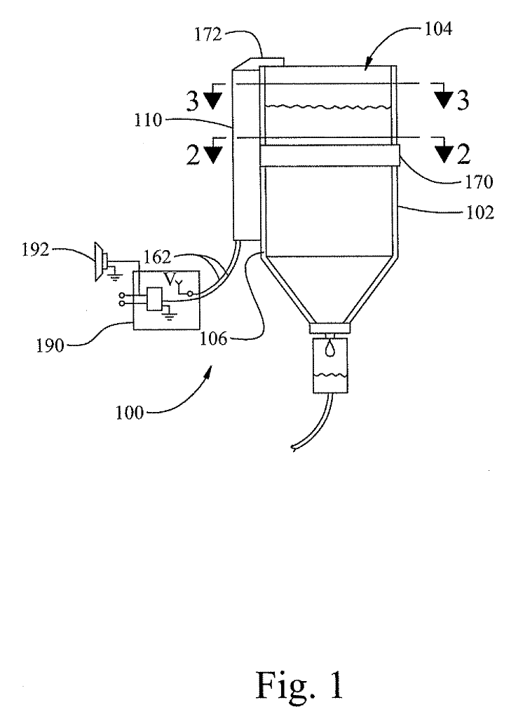

According to one embodiment of a fluid level sensor device 100, shown in FIGS. 1-4, the level of fluid in an infusion container 102 can be determined in a noninvasive manner by a fluid level detector 110 having a light source 120 and a light sensor array 130. The fluid level sensor device 100, in use, is connected to a container 102 for holding a volume of infusion fluid, such as Balanced Salt Solution (BSS). The container 102 is a rigid walled container having an interior volume 104 and at least a container side wall 106 defining a portion of interior volume 104. The container side wall 106, and the volume 104 are generally exposed to a light source 120 and a light sensor array 130, both of which are positioned vertically relative to the side wall 106, such that light emitted from the light source 120 is projected into at least a portion of the container 102 adjacent the fluid level detector 110. The side wall 106 is preferably made of translucent material. Container 102 is shown in the present example, having a cylindrical side wall 106 however, other side wall configurations may be used, such as square or rectangular cross-sectional shaped side walls.

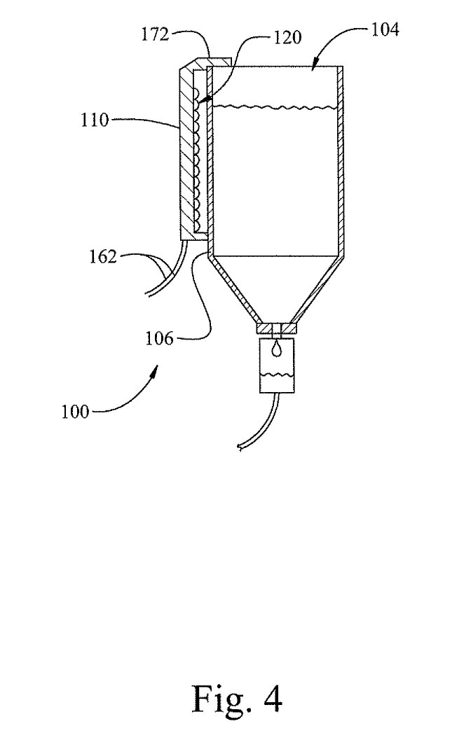

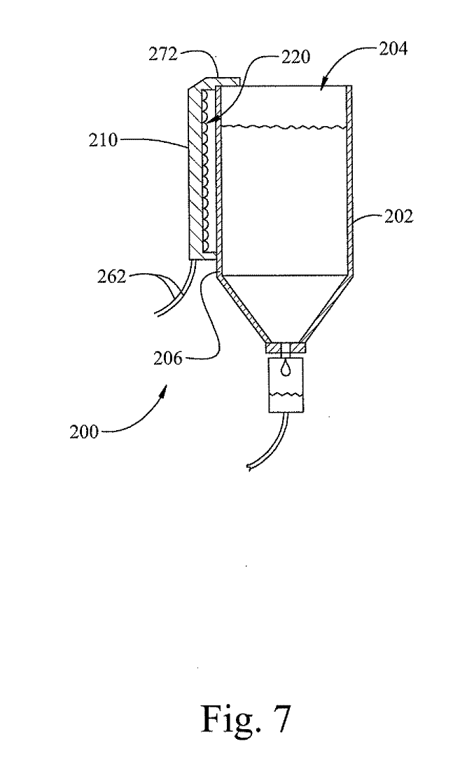

The fluid level sensor device 100 may comprise a fluid level detector 110 that integrally includes a light source 120 for projecting light linearly through a vertical portion of at least the side wall 106 of the container 102, and a linear array 130 of vertically arranged light sensors to detect the light reflected by the side wall 106. The light source 120 is positioned vertically relative to the side wall 106, and may comprise a plurality of light sources that are vertically arranged to project light at vertically spaced positions along the side wall 106, as shown in FIG. 4. The linear light source 120 may alternatively comprise a single light emitter that projects light linearly (not shown), or a single light source having a plurality of light emitters in a linear arrangement for emitting light from a plurality of different vertical positions, which emitters extend approximately the length of the side wall 106 (as shown in FIG. 7, for example). The vertically arranged light sensor array 130 is configured to receive and detect reflected light from light source 120 projected at the container side wall 106. The light sensor array 130 preferably includes vertically arranged light sensors, which can be, for example, pixels, separate sensors, or other mechanisms for sensing illumination. For example, the light sensor array 130 may comprise a plurality of light sensors located at a plurality of different vertical positions extending approximately the length of the side wall 106 each location of a light sensor potentially corresponding to a different fluid volume level.

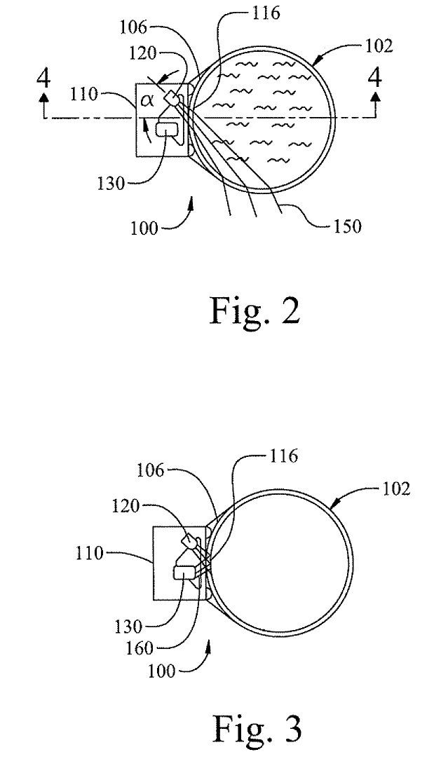

As shown in FIGS. 2 and 3, the fluid level sensor device 100 projects light from a linear light source into the side wall 106 of the container 102, which may be made of ABS plastic, acrylic or other suitable translucent material. Depending on the amount of light reflected or refracted in the container due to the side wall/liquid interface, certain portions of a linear light sensor array 130 may be illuminated. Specifically, refraction of light occurs at the interfaces between: (i) the air and side wall 106, and (ii) side wall 106 and fluid or air within the volume 104. The refraction or offset of light waves is slightly greater when light passes through the infusion fluid than when light passes through air within the interior volume 104. The light sensor array 130 is positioned on the side wall 106, such that, in use, the presence or absence of light at various points vertically along the light sensor array 130 indicates a fluid level of the container 102. Based on the transition between the presence and absence of light at a vertical location of the light sensor array 130, a level of the infusion fluid in the container 102 can be detected.

The side wall 106, through which the light source 120 is projecting is transparent. The light source 120 may be a linear light source, such as a linear LED light source, that produces light at various vertical points extending approximately a length of the side wall 106, as shown in FIG. 4. Preferably, the light produced by light source 120 provides uniform parallel light beams.

The light sensor array 130 may be a linear sensor array, such as a linear photo detector or photo diode that detects light emitted by light source 120 at various vertical locations extending approximately the length of the side wall 106, wherein each vertical position corresponds to a different fluid volume level.

In operation, the linear light source 120 acts as an emitter to emit light while the vertically arranged light sensor array 130 acts as receiver. An angle of incidence α of an emitted light beam of light source 120 relative to the container side wall 106 can be selected so that the light rays being reflected illuminate one or more light sensors of light sensor array 130 at a vertical location adjacent where air is in a particular portion of the container 102. As shown in FIG. 2, the light rays emitted by the light source 120 will not illuminate the light sensor array 130 at a vertical location adjacent where fluid is in the particular portion of the container 102, since the light will not be reflected at the side wall/fluid interface. FIG. 2 illustrates one or more light beams 150 that pass through infusion fluid or liquid in the container 102. The light beam 150 passes through side wall 106, through the fluid in the container 102, through the side wall 106 again on a generally opposite side, and therefore does not reflect or illuminate portions of the light sensor array 130 adjacent the fluid.

Alternatively, the light beam 160 shown in FIG. 3 does not pass through the interior volume 104 containing air at the top of the container 102. The angle of incidence α of the emitted light relative to the container wall 106 is selected, such that light beam 160 is reflected at surface interface 116 when it intersects a point adjacent where air is in the interior volume 104, at the side wall/air interface. The reflected light beam 160 is reflected at surface interface 116, and impinges on the light sensor array 130. With the appropriate incident angle α, the light beam 160 at surface interface 116 can be mostly reflected, because the refraction index of the side wall 106 material is greater than that of air. With the light beam 160 mostly reflected, the light beam 160 illuminates the light sensor array 130.

The appropriate angle of incidence α of light beams relative to the container walls may be determined by the refraction index of air, the refraction index of the infusion fluid (e.g., BSS) and of the side wall material. In the first embodiment, the angle of incidence α is chosen so that a light beam can pass through the infusion fluid within the container and avoid the light sensor array 130, but is reflected when the light beam intersects the point of the interface 116. Accordingly, with the incidence α of the first embodiment, the light beam 150 is mostly not reflected when the transmission path of the light intersects the side wall/fluid interface, but the light beam 160 may be completely reflected when the transmission path of the light intersects the side wall/air interface. Thus, when fluid is absent at a given level, the light sensor array 130 outputs a signal based on the presence of light at the sensor location corresponding to the absence of fluid, and when fluid is present at a given level, the light sensor array 130 output is affected by the absence of light at the sensor location due to the presence of fluid in the container 102.

The linear light source 120 and light sensor array are connected via electrical wires 162 to a circuit 190 that monitors the output of different portions of the light sensor array 130 to determine which portions of the light sensor array 130 indicate the presence of infusion fluid. The transition between the presence and absence of light at a vertical location of the light sensors indicates the fluid level within the container 102.

The circuit 190 may comprise a voltage source “V” and a processor or other component configured to receive an input from the sensor array 130, which provides an output indicative of the level of infusion fluid. The circuit 190 may be further configured to activate an audible alarm 192 upon detecting that the amount of infusion fluid within the container has been depleted below a minimum level. The fluid level sensor assembly 100 may further include an aperture in front of the light sensor array 130 to reduce the amount of external ambient light or stray light impinging on the light sensor array 130. The fluid level sensor assembly 100 further includes a clamp 170 for securely clamping the fluid level detector 110 in place on the container 102, to minimize movement during use of the infusion container and fluid level sensor assembly. The clamp 170 may be configured to clamp around the sides of the container 102, and can include a portion 172 to abut the top of the container 102, the bottom of the container, or otherwise clamp to the container 102.

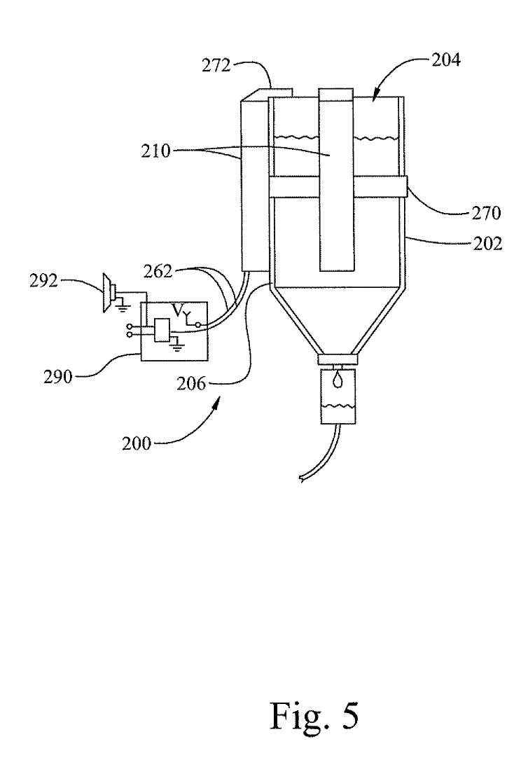

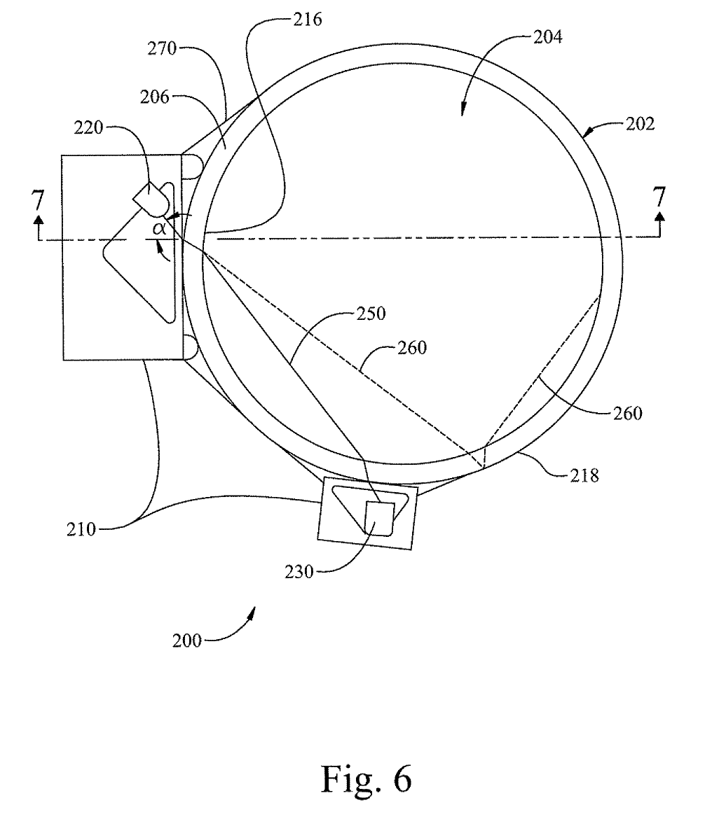

In a second embodiment of a fluid level sensor assembly 200, shown in FIGS. 5, 6, and 7, the level of fluid in the container 202 can be determined in a noninvasive manner by a fluid level detector 210 having a light source 220 and a light sensor array 230. The fluid level sensor assembly 200 is connected to a container 202 for holding a volume of infusion fluid, such as a Balanced Salt Solution (BSS). The container 202 includes a container side wall 206 defining at least a portion of an interior volume 204 of the container 202. A light source 220 and a light sensor array 230 are spaced apart on the side wall 206, such that light emitted from the light source 220 may be projected into the container 202 and towards the sensor array 230.

The infusion container 202 and fluid level sensor assembly 200 include a light source 220 for projecting light linearly through a vertical portion of side wall 206, and a vertically arranged light sensor array 230 to detect the light refracted through the container 202. The light source 220 is positioned vertically relative to the side wall 206, and may comprise a single light emitter (not shown) that projects light linearly, or a single light source having a plurality of light emitters in a linear arrangement for emitting light from a plurality of different vertical positions, which emitters extend approximately the length of the side wall 106, as shown in FIG. 7. The linear light source 120 may alternatively comprise a plurality of light sources that are vertically arranged to project light at vertically spaced positions along the wall 106 (as shown in FIG. 4). The vertically arranged light sensor array 230 can receive light from light source 220 projected at the container 202. The light sensor array 230 preferably includes vertically arranged light sensors, which can be, for example, pixels, separate sensors, or other mechanisms for sensing light. For example, the light sensor array 230 may comprise a plurality of light sensors located at a plurality of different vertical positions extending approximately the length of the side wall 206, each location of which may correspond to a different fluid volume level.

As shown in FIG. 5, the fluid level sensor assembly 200 projects light from a linear light source into the side wall 206, which may be made of ABS plastic, acrylic or other suitable translucent material. Depending on the amount of light reflected or refracted by the container due to the side wall/fluid interface, certain portions of a linear light sensor array 230 may be illuminated. Specifically, refraction of light occurs at the interfaces between: (i) the air and container wall 206, and (ii) container wall 206 and fluid or air within the volume 204 of the container 202. The refraction or offset of light waves is greater when light passes through the infusion fluid than when light passes through air in interior volume 204. The light sensor array 230 positioned on the side of the container 202 is configured such that the presence or absence of light at various points vertically along the light sensor array 230. Based on the transition between the presence and absence of light at a vertical location of the light sensor array 230, the level of the infusion fluid in the container 202 can be detected.

The side wall 206 between light source 220 and light sensor array 230 is transparent. The light source 220 may be a linear light source, such as a linear LED light source, that produces light at various vertical points. Preferably, the light produced by light source 220 provides uniform parallel light beams. The light sensor array 230 may be a linear sensor array (i.e., a continuous sensor array), such as a linear photo detector or photo diode, that detects light emitted by light source 220 at various positions.

In operation, the linear light source 220 acts as an emitter to emit light while the vertically arranged light sensor array 230 acts as receiver. As shown in FIG. 5, an angle of incidence α of the emitted light relative to the side wall 206 can be selected so that light rays being projected into the container 202 illuminate one or more light sensors of light sensor array 230 when passing through air in the container 202, but do not illuminate the light sensor array 230 when passing through fluid in the container 202. FIG. 5 illustrates a light beam 250 that passes through air in the container 202. Light beam 250 passes through container wall 206, through the air in the top of the container 202, again through container wall 206 and illuminates portions of the light sensor array 230.

Alternatively, a light beam 260 passes through infusion fluid in the container 202. The light beam 260 is refracted at surface 216 when it enters the infusion fluid at the side wall/fluid interface. The refracted light beam 260 is further reflected at surface 218 when it again reaches container wall 206, and does not impinge on the light sensor array 230. With an appropriate α, the light beam 260 at surface 218 can be mostly reflected because a refraction index of the side wall material is greater than that of air. With the light beam 260 mostly reflected, the light beam 260 does not illuminate the light sensor array 230. The appropriate angle of incidence α of light beams relative to the side wall 206 may be determined by the refraction index of air, the refraction index of the infusion fluid (e.g., BSS), and the refraction index of the material. Preferably, the angle of incidence α is chosen so that a light beam can pass through the air to reach the light sensor array 230, but is refracted or reflected away from array 230 when the light beam passes through the infusion fluid in the container 202.

Accordingly, light beam 250 is not reflected when the transmission path of the light intersects the side wall/air interface, but light beam 260 may be mostly or completely reflected when the transmission path of the light intersects the side wall/fluid interface. Thus, when fluid is absent at a given level, the light sensor array 230 outputs a signal based on the presence of light at the sensor location corresponding to the absence of fluid, and when fluid is present at a given level, the light sensor array 230 output reflects an absence of light at a sensor location adjacent the given level due to the presence of fluid at the given level.

The linear light source 220 and light sensor array 230 are connected to a circuit 290 that monitors the output of different portions of the light sensor array 230 to determine which portions of the light sensor array 230 indicate the presence of liquid or infusion fluid. The transition between the presence and absence of light at a vertical location of the light sensor array indicates the fluid level within the container 202. The circuit 290 may comprise a voltage source “V” and a processor or other component configured to receive an input from the sensor array 230, which provides an output indicative of the level of infusion fluid. The fluid level sensor assembly 200 may further include an aperture in front of the light sensor array 230 to reduce the amount of external ambient light or stray light. The fluid level sensor assembly 200 further includes a clamp 270 that securely clamps the fluid level detector 210 in place on the container 202, to minimize movement during use of the infusion container and fluid level sensor assembly. The clamp 270 may be configured to clamp around the sides of the container 202, and can include a portion 272 to abut the top of the container 202, the bottom of the container, or otherwise clamp onto the container.

In the above embodiment, the circuit 290 may further be configured to activate an audible alarm 292 based on the infusion fluid level within the container. As the amount of fluid in the container is depleted, a warning can be generated at a minimum level. The circuit 290 will continuously monitor the level of fluid detected, to provide a continuous update to the surgeon or staff so they are aware of how much infusion fluid is used. By continuously monitoring the amount of fluid in the bottle, the surgeon and staff can be warned when the amount of fluid in the container is about to be exhausted at a predetermined minimum level.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A fluid level sensor assembly for use in combination with an infusion fluid contained in a rigid walled container having an interior volume, and at least a container side wall defining a portion of the interior volume, the side wall being made of a translucent material, and the fluid level sensor assembly comprising:
a fluid level detector connected to a clamp and including a light sensor array and a light source;
the clamp for securely clamping the fluid level detector in place on the container, to minimize movement during use of the container and fluid level sensor assembly;
the light sensor array for being positioned vertically relative to the side wall, and configured to sense light at various points vertically along the light sensor array;
the light source for being positioned vertically relative to the side wall, and configured to project light linearly through a vertical portion of the side wall, wherein an incidence angle α of the light source relative to the side wall is such that a light beam emitted by the light source is not reflected when a transmission path of the light intersects a side wall/fluid interface, but a light beam is reflected when the transmission path of the light intersects a side wall/air interface; and
wherein when infusion fluid is absent in a vertical location of the container, the light sensor array outputs a signal based on a presence of light at a sensor location adjacent the vertical location corresponding to the absence of fluid at the vertical location, and when infusion fluid is present at a given level in the container, the light sensor array output reflects an absence of light at a sensor location adjacent the given level due to the presence of infusion fluid at the given level.

2. The fluid level sensor assembly of claim 1, wherein the linear light source comprises a plurality of light sources that are vertically arranged to project light at vertically spaced positions along the side wall.

3. The fluid level sensor assembly of claim 1, wherein the linear light source comprises a single light emitter that projects light linearly through the side wall.

4. The fluid level sensor assembly of claim 1, wherein the linear light source comprises a plurality of light emitters in a linear arrangement for emitting light from a plurality of different vertical positions, which emitters extend approximately a length of the side wall.

5. The fluid level sensor assembly of claim 1, wherein the light sensor array comprises a linear array of vertically arranged light sensors.

6. The fluid level sensor assembly of claim 1, wherein the light sensor array comprises a plurality of light sensors located at a plurality of different vertical positions extending approximately a length of the side wall, each location of light sensors may correspond to a different fluid level.

7. The fluid level sensor assembly of claim 1, wherein the light sensor array is configured, such that in use, the presence or the absence of light at various points vertically along the light sensor array indicates a fluid level of the container.

8. The fluid level sensor assembly of claim 1, further comprising a circuit in connection with the light sensor array, which circuit is configured to detect a transition between the presence and absence of light at a vertical location of the light sensor array, to indicate the level of fluid within the container.

9. The fluid level sensor assembly of claim 8, wherein the circuit is configured to activate an audible alarm upon detecting that the level of infusion fluid within the container has been depleted below a minimum level.

10. A fluid level sensor assembly in combination with an infusion fluid containing device, comprising:
a rigid walled container having an interior volume, and at least a container side wall defining a portion of the interior volume, the side wall being made of a translucent material,
a fluid level detector including a light sensor array and a light source;
a clamp that securely clamps the fluid level detector in place on the container, to minimize movement during use of the infusion container and fluid level sensor assembly;
the light sensor array positioned vertically relative to the side wall, and configured to sense light at various points vertically along the light sensor array;
the light source positioned vertically relative to the side wall, and configured to project light linearly through a vertical portion of the side wall;
wherein the light source and the light sensor array are spaced apart, such that light emitted from the light source may be projected into the container and towards the sensor array;
wherein an incidence angle α of the light source relative to the side wall is such that a light beam projected by the light source into the container illuminates a portion of the light sensor array when passing through air in the interior volume, and a light beam projected by the light source into the container does not illuminate the light sensor array when passing through fluid in the interior volume due to reflection of the light beam when the light beam intersects a side wall/fluid interface; and
wherein when infusion fluid is absent in a vertical location of the container, the light sensor array outputs a signal based on a presence of light at a sensor location adjacent the vertical location corresponding to the absence of fluid at the vertical location, and when infusion fluid is present at a given vertical location in the container, the light sensor array output reflects an absence of light at a sensor location adjacent the given vertical location due to the presence of infusion fluid at the given vertical location.

11. The fluid level sensor assembly of claim 10, wherein the linear light source comprises a plurality of light sources that are vertically arranged to project light at vertically spaced positions along the side wall.

12. The fluid level sensor assembly of claim 10, wherein the linear light source comprises a single light emitter that projects light linearly through the side wall.

13. The fluid level sensor assembly of claim 10, wherein the linear light source comprises a plurality of light emitters in a linear arrangement for emitting light from a plurality of different vertical positions, which emitters extend approximately a length of the side wall.

14. The fluid level sensor assembly of claim 10, wherein the light sensor array comprises a linear array of vertically arranged light sensors.

15. The fluid level sensor assembly of claim 10, wherein the light sensor array comprises a plurality of light sensors located at a plurality of different vertical positions extending approximately a length of the side wall, wherein each vertical position corresponds to a different fluid volume level.

16. The fluid level sensor assembly of claim 10, wherein the light sensor array is configured, such that the presence or absence of light at various points vertically along the light sensor array indicates a fluid level of the container.

17. The fluid level sensor assembly of claim 10, further comprising a circuit in connection with the light sensor array, which circuit is configured to detect a transition between the presence and an absence of light at a vertical location of the light sensor array, to thereby detect the level of the infusion fluid in the container.

18. The fluid level sensor assembly of claim 17, wherein the circuit is configured to activate an audible alarm upon detecting that the amount of infusion fluid within the container has been depleted below a minimum level.
